(19) United States
(12) Patent Application Publication
(10) Pub. No.: US 2003/0004969 A1
(43) Pub. Date: Jan. 2, 2003

(54) Material and process data application system used in manufacturing a semiconductor device

(76) Inventors: Young-hwan Park, Yongin-city (KR); Chay-ryang Jeong, Osan-city (KR)

Correspondence Address: LEE & STERBA, P.C., Suite 2000, 1101 Wilson Boulevard, Arlington, VA, 22209, US

(21) Appl. No.: 10/178,756

(22) Filed: Jun. 25, 2002

(30) Foreign Application Priority Data
Jun. 30, 2001 (KR) 01-38816

(51) Int. Cl. G06F 7/00

(52) U.S. Cl. 707/104.1

(57) ABSTRACT

A system and method for improving yields in a semiconductor manufacturing facility includes a computerized receiving inspection module and a computerized process tracking module, both of which are database driven and both being structured to facilitate use of bar-codes and database queries. The receiving inspection module further includes a supplied data reception module and a materials inspection/analysis module for generating data values to be stored in a materials database. The process tracking module further includes data measuring modules and statistical analysis modules for optimizing the quality of received materials, optimizing the specifications used for testing to be conducted on both the materials and a manufactured semiconductor device, and optimizing the characteristics and parameters relating to semiconductor manufacturing processes.

### BACKGROUND OF THE INVENTION

1. Field of the Invention

The present invention relates to a system for managing materials used in manufacturing a semiconductor device. More particularly, the present invention relates to a system for ensuring the quality of materials and for applying the materials to a process for manufacturing a semiconductor device.

2. Description of the Related Art

In order to manufacture a semiconductor device, a manufacturer first places an order for materials required to manufacture the semiconductor device. The manufacturer then inspects the ordered materials for physical/electrical characteristics required for manufacturing of the semiconductor device. This procedure is referred to as inspection. As a result of the inspection procedure, if the ordered materials satisfy a predetermined standard, the materials are used in a semiconductor manufacturing process. Here, the materials may include wafers, chemicals and gases used in an etching or a cleaning process, photoresists used in a lithographic process, and targets used in a sputtering process.

A procedure for the inspection of materials used in manufacturing a semiconductor device will be now described in detail. A supplier provides a manufacturer with a certificate of analysis (COA), which is a certification of material quality. Representative items which may be included in the COA are types of materials, identity of a manufacturer of each of the materials, a quantity of each material, and physical/electrical test characteristics of the materials when sent and their measured values (referred to as data for selecting materials). In a case where the materials are wafers, the items which represent the physical/electrical characteristics of the materials may include a caliber of a wafer, resistors, a crystal direction, a thickness dimension, and a surface flatness measure.

A manufacturer may also provide an advanced supplier management system (ASMS) in addition to a COA. The ASMS includes information that represents electrical and physical states of intermediate materials at the time of the shipping of the materials, as distinguished from a COA, which specifies finished materials at the time of shipment.

Typically, a manufacturer manually tests for and prepares the COA and ASMS, including the raw materials and sub-materials, to determine whether the materials are acceptable or defective. This activity represents a significant reduction in manpower and productivity due to the management of the COA and the inspection procedures, which occur continuously.

Since measured data values of main items included in a COA are typically provided in the form of a paper, it is difficult to reliably and continuously manage the items to ensure the quality of the materials. Some of the data values, however, may be provided in the form of an electronic file in which part of the data is stored according to requirements of a manufacturer or an inspector. These data values, in the form of an electronic file, may be managed by a computer. In cases where only part of the data is managed by a computer, it is difficult to check relationships with data that is provided in the form of a paper. In both instances, reliability and accuracy of information included in a managed file are reduced.

To overcome problems associated with the above procedure, data included in COA and ASMS is typically analyzed manually, and specific charts are drawn in order to ensure the received materials meet quality specifications. Moreover, data obtained during the inspection procedure of materials may have no relationship with a process for manufacturing a semiconductor device. Work registers having materials for a process for manufacturing a semiconductor device are checked when a portion of the materials have been used, and data related to the corresponding materials and data related to a process of manufacturing a semiconductor device are manually searched before the materials are applied to a process for manufacturing a semiconductor device.

### SUMMARY OF THE INVENTION

In an effort to solve the above problem, it is a feature of an embodiment of the present invention to provide a system capable of automatically performing a quality control inspection of received materials to reduce reductions in manpower and manufacturing productivity.

It is a second feature of an embodiment of the present invention to provide a system capable of continuously and reliably managing databases generated from a certificate of analysis (COA) of materials and data received from an advanced supplier management system (ASMS) of materials.

It is a third feature of an embodiment of the present invention to provide a system capable of applying materials to a process for manufacturing a semiconductor device.

According to a preferred embodiment of the present invention, a Material And Process data application system (MAPLE) preferably includes: a database for storing data values including a certificate of analysis (COA)/advanced supplier management system (ASMS) database file (DBF), in which measured data values for selecting materials provided by a supplier are stored, a specification (spec) DBF, in which reference data values for selecting materials are stored, and a program module. The program module preferably includes a recipient's decision module for downloading the measured data values related to specific materials from the COA/ASMS DBF and for determining whether the measured data values are in a range of the reference data values. The materials may include one or more material selected from the group consisting of wafers, chemicals, reactive gases, photoresists, and targets.

Preferably, the program module may further include a COA/ASMS analysis module for downloading data values related to materials from the COA/ASMS DBF and the spec DBF, analyzing the data values for selecting materials according to the reference data values using a statistical management method, and outputting a result of the analysis. The statistical management method may include a technical statistical quantity for each material or for each of the data values for selecting materials, a trend analysis module, a comparative analysis module, and a relative analysis module.

Preferably, the database may also include a bar coding DBF in which bar coding data values for applying the data for selecting materials to a process of manufacturing a semiconductor device are stored, and a process DBF which stores data values related to a process for manufacturing a semiconductor device performed after the materials are introduced to process facilities for manufacturing a semiconductor device. Preferably, the program module further includes a material/process application analysis module for downloading COA/ASMS data values, specification data values, bar coding data values, and process data values for each lot of given materials from the COA/ASMS DBF, the spec DBF, the bar coding DBF, and the process DBF, respectively, for applying the quality of the materials to a process for manufacturing a semiconductor device for each lot, and for optimizing the specification of the data values for selecting materials. The bar coding data values preferably include data values related to a type of a manufacturing process, the characteristics of a manufacturing facility, and a time data value for introducing/eliminating the materials to/from the manufacturing facility. The process data values preferably include data values, which specify a final product including the starting and ending time of the manufacturing process, and a yield of the final product.

Additionally, the program module may preferably further include a report module for downloading the COA/ASMS data values for each lot of the given materials, the specification data values, the bar coding data values, and the process data values from the COA/ASMS DBF, the spec DBF, and the bar coding DBF, and the process DBF, respectively, for quantitatively analyzing the productivity and economy of the final product of the materials due to the guarantee of the quality of the materials, and for outputting the results of the analysis. A capability index and a sigma standard for each material or for each data for selecting materials may be derived from the quantitative analysis of the productivity and economy of the final product.

Accordingly, the embodiments of the present invention provide significant improvements in the accuracy and speed of inspection decisions regarding the materials to be used, thereby allowing the data for selecting materials to be continuously and reliably managed. Further, the “approved” materials may be directly applied to a process for manufacturing a semiconductor device, thereby improving the yield of a process, preventing defects and abnormalities in processes caused by the materials, and/or quickly finding the cause of defects when defects occur.

### BRIEF DESCRIPTION OF THE DRAWINGS

These and other features and advantages of the present invention will be readily apparent to those of ordinary skill in the art upon review of the detailed description that follows with reference to the attached drawings in which:

FIG. 1 illustrates a schematic diagram of a Material And Process data appLication systEm (MAPLE) according to an embodiment of the present invention.

FIG. 2 is a flow chart showing representative steps for automatically determining the inspection procedure of materials using a MAPLE according to an embodiment of the present invention.

FIG. 3 is a flow chart showing representative steps for analyzing data of a certificate of analysis (COA) and data of an advanced supplier management system (ASMS) and obtaining the analyzed result using a MAPLE according to an embodiment of the present invention.

FIG. 4 is a flow chart showing representative steps of optimizing physical/electrical characteristics of materials and of checking variation in yield of a product by using materials for each lot, bar coding data corresponding to the materials, and process data, in a MAPLE according to an embodiment of the present invention.

### DETAILED DESCRIPTION OF THE INVENTION

Korean Patent Application No. 01-38816, filed on Jun. 30, 2001, and entitled: “Material and Process Data Application System Used in Manufacturing a Semiconductor Device,” is incorporated by reference herein in its entirety.

Hereinafter, the present invention will be described in detail by describing preferred embodiments of the present invention with reference to the accompanying drawings.

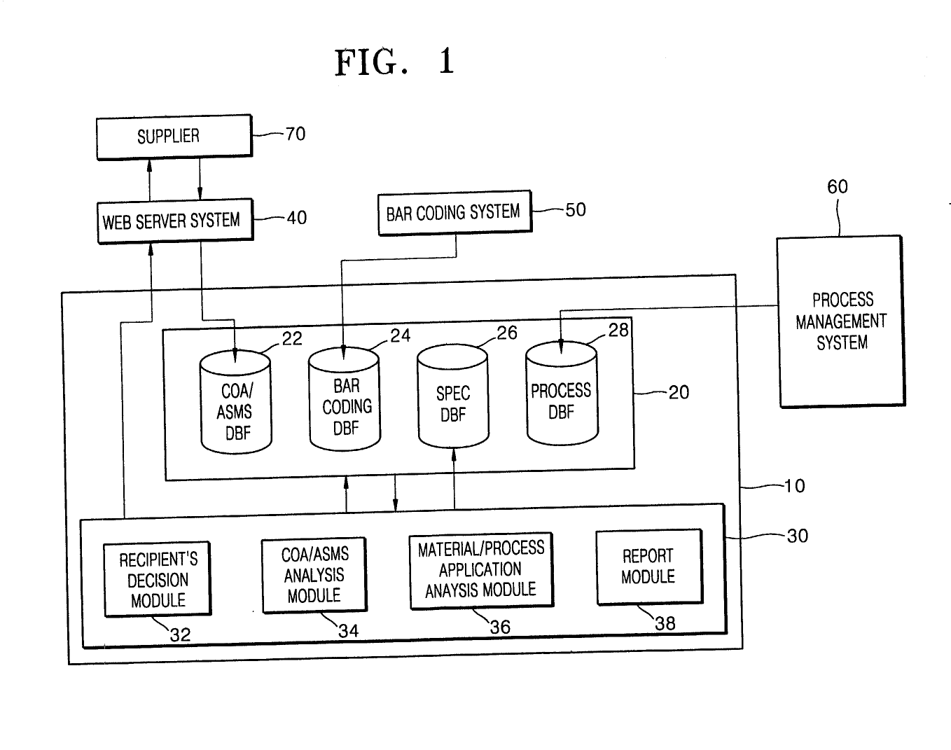

FIG. 1 illustrates a system for guaranteeing the quality of materials and applying the materials to a process for manufacturing a semiconductor device according to an embodiment of the present invention, which is referred to as a Material And Process data appLication systEm (MAPLE) 10. The MAPLE 10 preferably includes a MAPLE database 20 and a MAPLE client program module 30 further including four software modules. The MAPLE database 20 includes a certificate of analysis (COA)/advanced supplier management system (ASMS) database file (DBF) 22, a bar coding DBF 24, a specification (spec) DBF 26, and a process DBF 28.

If a supplier 70 transmits COA/ASMS data values as an electronic file to a web server system 40 in a manufacturer's web site, the web server system 40 stores the COA/ASMS data values in the COA/ASMS DBF 22 in the MAPLE 10 using a download program having a file transfer protocol (FTP). Measured data values related to materials at a time of shipping and during manufacturing of a higher-level product of the supplier 70 are also preferably stored in the COA/ASMS DBF 22. As previously described, the data values related to the materials may include: types of materials, identity of a manufacturer, a quantity, and physical/electrical characteristics at the time of shipping and their measured values (referred to as data values for selecting materials). In a case where the materials are wafers, the items that represent the physical/electrical characteristics of the materials may include a caliber of a wafer, resistors, a crystal direction, a thickness dimension, and a surface flatness measure.

A user, (e.g., a purchaser or an inspector of materials), generates a specification file containing reference data values for each material corresponding to the COA/ASMS data values and then stores the specification file in the spec DBF 26. Specification data values and tolerances of data values for selecting materials that are for a special use according to demands of a manufacturer are also preferably stored in the spec DBF 26. In a case where the materials are wafers, the data values may include a caliber of a wafer, resistors, a crystal direction, a thickness dimension, and a surface flatness measure.

Data values stored in the bar coding DBF 24 are preferably provided from a bar coding system 50 using a download program. The bar coding system 50 may be a system that automatically scans bar codes of materials introduced to a facility for manufacturing a semiconductor device, reads time data values (i.e., a time for introducing and eliminating materials) stored in the bar codes, and manages the data. A facility for manufacturing a semiconductor device may include process facilities in which a given process for a wafer is performed, for example, a deposition process or a lithographic process, and may incorporate supply facilities connected to the process facilities for supplying materials required to perform the process and/or to support performing the process, for example, supplying process gases and chemicals.

The data values stored in the bar coding DBF 24 preferably include data values related to a manufacturing process using specific materials required for manufacturing a semiconductor device, data values related to manufacturing facilities, and time data values related to a time for introducing materials. As described above, the manufacturing process may include unit processes for manufacturing a semiconductor device, such as a diffusing process, a deposition process, a photolithographic process, or an interconnection process. The time for introducing materials represents a period of time from a start time to an end time (i.e., output time) for introducing specific materials.

Some materials may be introduced in the process facilities, and other materials may be introduced through the supply facilities, with process data values being measured after a predetermined time. The measured process data values are preferably stored in the process DBF 28, with the data values taken from the bar coding DBF 24. In an exemplary etching process, process data values measured and stored in process DBF 28 may include identification of the etching equipment, a start time and an end time of the etching process, physical characteristics of a semiconductor device after completion of the etching process, and data values (i.e., final product selecting data values) related to select dimensions of the etched traces on the semiconductor device. The process data values described above are preferably provided from a process management system 60, which manages process data values on specific conditions in each production line, as shown in FIG. 1.

The four modules included in the MAPLE client program module 30 preferably include a recipient's decision module 32, a COA/ASMS analysis module 34, a material/process application analysis module 36, and a report module 38. In a preferred embodiment, the recipient's decision module 32 reads data from the COA/ASMS DBF 22 and the spec DBF 26 and automatically determines whether the materials are to be introduced to a production process. The COA/ASMS analysis module 34 downloads data from the COA/ASMS DBF 22 and the spec DBF 26 and analyzes the COA/ASMS data using a statistical management method. The material/process application analysis module 36 downloads data from the COA/ASMS DBF 22, the bar coding DBF 24, the spec DBF 26, and the process DBF 28, applies data related to quality of materials to data related to a process of manufacturing a semiconductor device, and evaluates the characteristics of the materials, thereby optimizing the specification of the materials, and thus improving yield of a product.

The recipient's decision module 32, the COA/ASMS analysis module 34, and the material/process application analysis module 36 provide a means for improving the physical and electrical characteristics of materials, the process for manufacturing the semiconductor device, and yield of the manufacturing process (i.e., a technical improvement). The report module 38 analyzes the economic effect of the above-mentioned technical improvement and outputs the analyzed result. More specifically, the report module 38 reads data from the COA/ASMS DBF 22, the spec DBF 26, the bar coding DBF 24, and the process DBF 28; analyzes the quantity of materials, calculates a potential capability index (Cp), an actual capability index (Cpk), and a sigma standard; and outputs the analyzed result.

Capability indices (including a Cp and a Cpk) represent an amount of variation in the quality of a product as represented by a sigma standard. The sigma standard is a business index representing the result of a process for specification. The sigma standard may be used as an index of both current management of the semiconductor manufacturing process and for setting future objectives of an enterprise. Thus, if the capability indices are high, the sigma standard becomes relatively higher, and the productivity and economy accordingly increase.

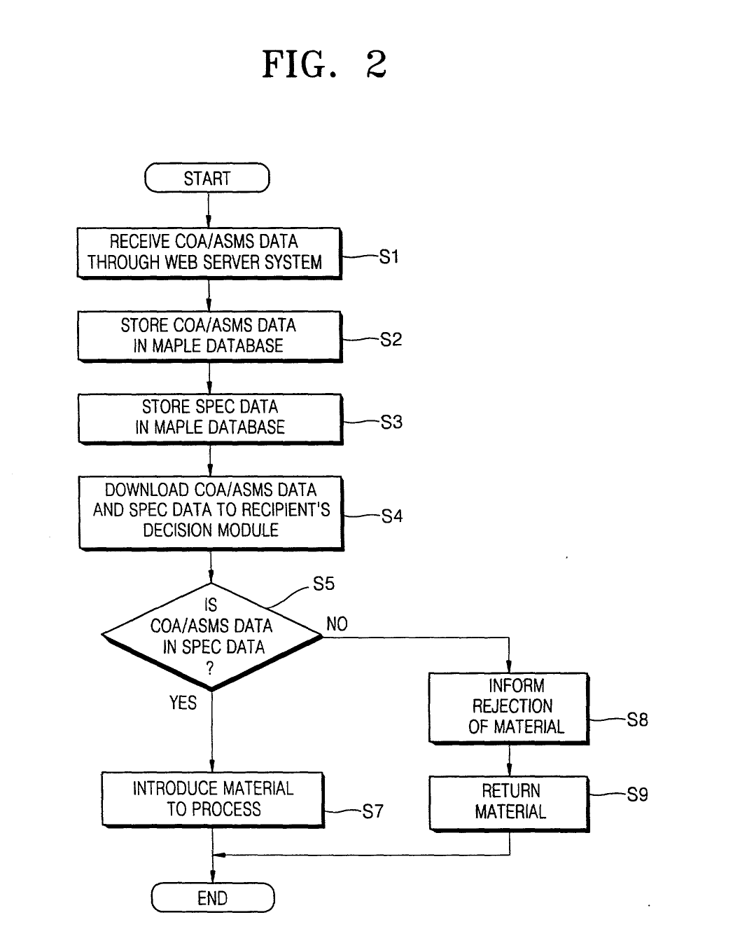

A recipient's decision method, a COA/ASMS data analysis method, and a method for applying the quality of materials to a process/yield are described with reference to FIGS. 2 through 4, respectively.

Referring to FIG. 2, in steps S1 and S2, COA/ASMS data values provided by the supplier 70, are preferably received through the web server system 40 and stored in the COA/ASMS DBF 22 in the MAPLE database 20, respectively. In step S3, the specification data values of items to be inspected are also preferably stored in the spec DBF 26. In order to perform automatic quality assurance decisions on items to be inspected, in step S4, corresponding data values from the COA/ASMS DBF 22 and the spec DBF 26 are downloaded to the recipient's decision module 32 in the client program module 30.

In step S5, the downloaded data values are compared in the recipient's decision module 32. More specifically, it is determined whether the COA/ASMS data values are in the range of the reference data values from the spec DBF. If the COA/ASMS data values are in the range of the reference data values from the spec DBF, it is determined that materials are acceptable, and, in step S7, the accepted materials are introduced to the manufacturing process.

In the manufacturing process, the materials are controlled by the bar coding system 50 and the process management system 60. Data values generated during the production process are also preferably managed by the bar coding system 50 and the process management system 60. Alternatively, if the COA/ASMS data values are not in the range of the specification data values, in step S8, the materials are rejected and a corresponding information message is generated, and, in step S9, the rejected materials are returned. Thus, by using the COA/ASMS data system, the time it takes for an inspector to perform an inspection of materials can be greatly reduced and greater accuracy in the inspection can be achieved.

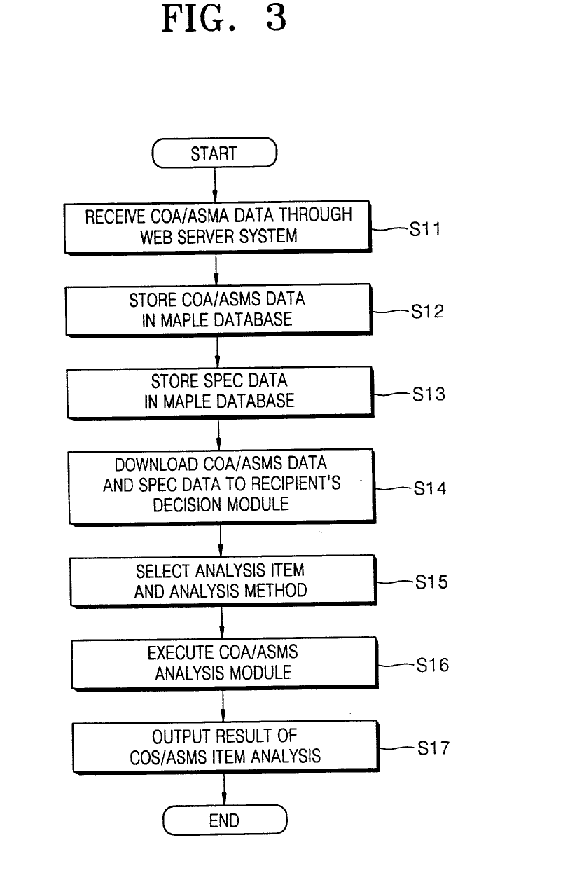

In addition to the aforementioned quality assurance and control process regarding the inspection of materials, a COA/ASMS analysis procedure may more effectively manage the COA/ASMS data. A COA/ASMS analysis procedure is shown in FIG. 3.

For the analysis procedure, steps similar to steps S1 through S4 of FIG. 2 are performed. Specifically, in steps S11 and S12, the COA/ASMS data values are received through the web server system 40 and stored in the COA/ASMS DBF 22 in the MAPLE database 20, respectively. In step S13, the specification data values (i.e., reference data values) are also stored in the spec DBF 26. In step S14, corresponding data values in the COA/ASMS DBF 22 and the spec DBF 26 are downloaded to the recipient's decision module 32 in the client program module 30 in response to a COA/ASMS analysis command from the MAPLE client program module 30. The downloaded specification data values and the COA/ASMS data values are processed using various statistical methods, such as trend analysis, comparative analysis, relative analysis, and technical statistical quantity.

Comparative analysis also allows a difference between manufacturers of materials to be analyzed and output. Specifically, if a user, (e.g., an inspector), selects an analysis method and an analysis item in step S15, the MAPLE client program module 30 is executed in step S16, and a result from the analysis of the input item is output in step S17.

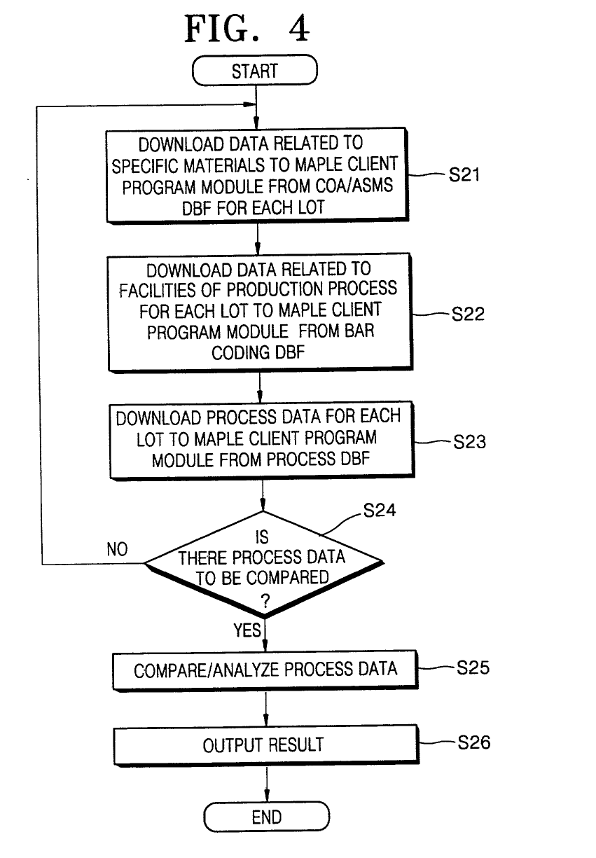

FIG. 4 shows a method for applying the quality of materials to a process/yield derivation process in which it is assumed that the COA/ASMS data is continuously provided from the supplier 70, and contents of the COA/ASMS are systemized to the COA/ASMS DBF 22 of the MAPLE database 20, and bar coding data for introducing materials to manufacturing facilities and process data for each production line and for each lot of materials are systematically managed in the bar coding DBF 24 and the process DBF 26.

Under the above-described conditions, in step S21, data values for specific materials are downloaded to the MAPLE client program module 30 from the COA/ASMS DBF 22 for each lot in response to a query of a user or an inspector. Simultaneously, the specification data values for specific materials are also downloaded to the MAPLE client program module 30. Data values for materials in each lot preferably include items for determining the physical characteristics of materials, their measured values, and time for introducing and eliminating materials. In a next step S22, data values related to facilities being used in the a production process for each lot are downloaded to the MAPLE client program module 30 from the bar coding DBF 24 in response to a query of the downloaded data of materials for each lot of the material/process application analysis module 36. The data related to facilities in a production process may include: types of process facilities and/or supply facilities in which the materials are used and the time for introducing/eliminating materials to/from process facilities and/or supply facilities.

Next, in step S23, process data values corresponding to data values for each lot are downloaded to the MAPLE client program module 30 from the process DBF 28 in response to a query from the material/process application analysis module 36. The process data preferably includes parameters relating to manufacturing/inspection lines within which the processing of materials for each lot is performed, and data for a starting time, an ending time, and the yield of a process. Meanwhile, the data in the manufacturing/inspection lines may be queried and sent to the process DBF 28 with one or more queries relative to facilities or materials. At this time, data related to the starting and ending times and the process yields for queried lines are output.

At least two process data values relating to the same materials are required to analyze the process data values that depend on the quality of materials in the material/process application analysis module 36. Accordingly, after steps S21 through S23, in step S24, the material/process application analysis module 36 checks whether there are process data values to be compared. If there are no process data values to be compared, steps S21 through S23 are repeated. After enough process data values to secure the reliability of the data are obtained, in step S25, the obtained process data values are compared/analyzed. In a final step S26, the result of comparison/analysis is output as a text message or a chart to a monitor of a computer connected to the MAPLE 10 used by a worker or an inspector.

By using a comparison/analysis procedure on the process data, variances in the physical and electrical characteristics of a final product (final product selecting data) and the yield thereof may be monitored, particularly in cases where materials having different data values are manufactured under specific process conditions in specific facilities using the specification of unique materials. Further, optimum values for each unique parameter relating to a material, manufacturing facilities or manufacturing process that determine the physical and electrical characteristics of specific materials may be derived with reference to yield. Finally, optimization of the specification may be derived and applied to inspection decisions, thereby allowing inspection of materials to facilitate improvement in process yields.

In other words, data related to materials may be applied to data related to a process for manufacturing a semiconductor through the material/process application analysis module, thereby systematically and productively managing the manufacturing process.

According to the embodiments of the present invention, the COA/ASMS data values for inspection of materials, which are provided in the form of an electronic file, are preferably received and stored in a database, thereby automating and systemizing a receipt procedure. Thus, the quality of materials can be checked, and any abnormality in the quality of materials can be detected early. That is, incidents reducing the quality of the process for manufacturing a semiconductor may be prevented. Further, manpower and time related to inspection and receipt of materials can be reduced.

The COA/ASMS data for materials may be systematically managed, thereby ensuring the reliability and accuracy of the COA/ASMS data of materials. Thus, accurate information regarding the quality of materials is preferably made available to an inspector in real time. Meanwhile, the material quality data values are preferably applied to the process data, thereby optimizing the specification of materials and their characteristics to obtain a margin in a process and improved product yield. Further, even when there is an abnormality in a process, relationships to materials quality can be quickly and easily checked. Finally, the time required to obtain process-related data for semiconductor manufacturing processes and problem-solving activities may be reduced.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A Material And Process data appLication systEm (MAPLE) comprising:
a database for storing data values including a certificate of analysis (COA)/advanced supplier management system (ASMS) database file (DBF), in which measured data values for selecting materials provided by a supplier are stored, and a specification (spec) DBF, in which reference data values for selecting materials are stored; and
a program module including a recipient's decision module for downloading the measured data values related to specific materials from the COA/ASMSS DBF and determining whether the measured data values are in a range of the reference data values.

2. A MAPLE as claimed in claim 1, wherein the materials include one or more materials selected from the group consisting of wafers, chemicals, reactive gases, photoresists, and targets.

3. A MAPLE as claimed in claim 1, wherein the program module further comprises a COA/ASMS analysis module for downloading data values related to materials from the COA/ASMS DBF and the spec DBF, for analyzing the data values for selecting materials according to the reference data values using a statistical management method, and for outputting a result of the analysis.

4. A MAPLE as claimed in claim 1, wherein the statistical management method includes one or more from the group consisting of a technical statistical quantity for each material or for each of the data values for selecting materials, a trend analysis module, a comparative analysis module, and a relative analysis module.

5. A MAPLE as claimed in claim 1, wherein the database further comprises a bar coding DBF in which bar coding data values for applying the data values for selecting materials to a process for manufacturing a semiconductor device are stored, and a process DBF which stores data values including data values related to a process of manufacturing a semiconductor device performed after the materials are introduced to process facilities for manufacturing a semiconductor device; and wherein the program module further includes a material/process application analysis module for downloading COA/ASMS data values, reference data values, bar coding data values, and process data values for each lot of given materials from the COA/ASMS DBF, the spec DBF, the bar coding DBF, and the process DBF, respectively, for applying the quality of the materials to a process for manufacturing a semiconductor device for each lot, and for optimizing the specification of the data values for selecting materials.

6. A MAPLE as claimed in claim 5, wherein the bar coding data values comprise data values related to a type of a manufacturing process, data values related to characteristics of a manufacturing facility, and a time data value for introducing/eliminating the materials to/from the manufacturing facility, and the process data values includes data values which specify a final product including a starting and ending time of the manufacturing process and a yield of the final product.

7. A MAPLE as claimed in claim 6, wherein the program module further includes a report module for downloading the COA/ASMS data values for each lot of the given materials, the reference data values, the bar coding data values, and the process data values from the COA/ASMS DBF, the spec DBF, and the bar coding DBF, and the process DBF, respectively, for quantitatively analyzing the productivity and economy of the final product of the materials due to the guarantee of the quality of the materials, and for outputting a result of the analysis.

8. A MAPLE as claimed in claim 7, wherein a capability index and a sigma standard for each material or for each data value for selecting materials are derived from the quantitative analysis of the productivity and economy of the final product.

9. A MAPLE as claimed in claim 3, wherein the database further comprises a bar coding DBF in which bar coding data for applying the data values for selecting materials to a process of manufacturing a semiconductor device is stored, and a process DBF in which stores data values including data values related to a process of manufacturing a semiconductor device performed after the materials are introduced to process facilities for manufacturing a semiconductor device; and wherein the program module further includes a material/process application analysis module for downloading COA/ASMS data, reference data values, bar coding data values, and process data values for each lot of given materials from the COA/ASMS DBF, the spec DBF, the bar coding DBF, and the process DBF, respectively, for applying the quality of the materials to a process for manufacturing a semiconductor device for each lot, and for optimizing the specification of the data values for selecting materials.

10. A MAPLE as claimed in claim 9, wherein the bar coding data values comprises data values related to a type of a manufacturing process, data values related to a manufacturing facility, and a time data value for introducing/eliminating the materials to/from the manufacturing facility, and the process data values includes data values which specify a final product including a starting and ending time of the manufacturing process and a yield of the final product.

11. A MAPLE as claimed in claim 10, wherein the program module further comprises a report module for downloading the COA/ASMS data values for each lot of the given materials, the reference data values, the bar coding data values, and the process data values from the COA/ASMS DBF, the spec DBF, and the bar coding DBF, and the process DBF, respectively, for quantitatively analyzing the productivity and economy of the final product of the materials due to the guarantee of the quality of the materials, and for outputting a result.

12. A MAPLE as claimed in claim 11, wherein a capability index and a sigma standard for each material or for each data for selecting materials are derived from the quantitative analysis of the productivity and economy of the final product.
